(19) United States
(12) Patent Application Publication
(10) Pub. No.: US 2007/0298201 A1
(43) Pub. Date: Dec. 27, 2007

(54) EXPANDABLE OR EXPANDED MASTIC COMPOSITION FOR THE STRUCTURAL REINFORCEMENT OF A HOLLOW METAL BODY AND SUCH A HOLLOW BODY

(75) Inventor: Elise LABORBE, Villemandeur (FR)

Correspondence Address: OBLON, SPIVAK, MCCLELLAND MAIER & NEUSTADT, P.C., 1940 DUKE STREET, ALEXANDRIA, VA, 22314, US

(73) Assignee: HUTCHINSON, PARIS (FR)

(21) Appl. No.: 11/763,845

(22) Filed: Jun. 15, 2007

(30) Foreign Application Priority Data
Jun. 16, 2006 (EP) 06290987.4

(51) Int. Cl. C08G 63/48; B29D 22/00

(52) U.S. Cl. 428/36.8; 525/54.45

(57) ABSTRACT

The present invention relates to a hot-expandable or -expanded mastic composition which can be used for the structural reinforcement of a hollow metal body, to a process for preparing this composition, to such a hollow body and to a use of this composition. The invention applies in particular to body panels for motor vehicles, airborne vehicles and space vehicles. An expandable or expanded mastic composition according to the invention is based on at least one epoxy resin, and it also comprises at least one block copolymer chosen from the group consisting of copolymers of formula SBM and of formula MAM, where S, B, M and A respectively denote polymeric blocks predominantly derived from a vinylaromatic monomer, from a conjugated diene monomer, from methyl methacrylate and from an alkyl acrylate or methacrylate.

The present invention relates to a hot-expandable or -expanded mastic composition which can be used for the structural reinforcement of a hollow metal body, to a process for preparing this composition, to such a hollow body and to a use of this composition. The invention applies in particular to body panels for motor vehicles, airborne vehicles and space vehicles.

In a known manner, hollow metal bodies, such as body panels for motor vehicles, can be structurally reinforced with materials of rigid foam type. These reinforcing materials usually consist of compositions which are based on epoxy resins and which are provided so as to be expandable under the effect of heat, typically at a temperature ranging from 160° C. to 180° C., via a swelling agent that they contain.

Among the main properties desired for these expandable mastics—in addition to the properties of adhesion to metal once the composition has been crosslinked and expanded, of shear strength and of compression strength—mention may be made of their “uncured” tack (i.e. tack in the uncured state), their vertical creep stability during the heat treatment process and a low hardness. After expansion, a maximum degree of expansion is also desired for the expanded mastics, with closed cells so as to have minimal water absorption.

More specifically, these expandable mastics are usually based on two epoxy resins, respectively liquid and solid, which are mixed with an epoxy resin modified with an elastomer, such as a nitrile rubber (NBR) Reference may, for example, be made to document EP-B-1 163 288 for a detailed description of a composition that can be used for such an expandable mastic.

A major drawback of these known compositions of expandable mastics lies in the impossibility of simultaneously obtaining for the latter:
in the uncured state, a sufficiently low hardness which favours their subsequent use and an “uncured” tack of sufficient level which favours their adhesion to the metal wall of the hollow bodies intended to receive them, and
in the expanded state, a sufficiently low degree of water absorption.

Another drawback of these known compositions is that they often show great sensitivity to the type of surfactant used.

An aim of the present invention is to overcome these drawbacks, and this aim is achieved in that the applicant has just discovered, surprisingly, that the incorporation, into a composition of hot-expandable mastic based on at least one epoxy resin, of a block copolymer chosen from the group consisting of copolymers of formula SBM and of formula MAM, where S, B, M and A respectively denote polymeric blocks predominantly derived from a vinylaromatic monomer, from a conjugated diene monomer, from methyl methacrylate and from an alkyl acrylate or methacrylate, makes it possible to obtain a composition which particularly exhibits, in comparison with the known compositions, in the uncured state, a reduced hardness and an increased tacky nature with respect to metal materials and, in the expanded state, a reduced degree of water absorption, thereby rendering the compositions of the invention usable for satisfactory structural reinforcement of a hollow metal body.

It will be noted that the improved processability, the improved mastic/metal tack and the reduced water absorption, which are conferred on this composition according to the invention by said block copolymer(s), are obtained without penalizing the vertical creep stability of said composition, which is substantially of the same order as that obtained with the compositions of the prior art.

As vinylaromatic monomer from which the block S is predominantly derived, use may, for example, be made of styrene, alpha-methylstyrene or vinyltoluene. Preferably, this block S is predominantly derived from styrene and, even more preferably, this block S consists of polystyrene.

As conjugated diene monomer from which the block B is predominantly derived, use may, for example, be made of butadiene, isoprene, 2,3-dimethyl-1,3-butadiene, 1,3-pentadiene and 2-phenyl-1,3-butadiene. Preferably, this block B is predominantly derived from butadiene, and even more preferably, this block B consists of 1,4-polybutadiene.

As block M, use is preferably made of a block consisting of poly(methyl methacrylate) and, as block A, use is preferably made of a block predominantly derived from an alkyl acrylate, such as a butyl acrylate or an ethyl acrylate, and, even more preferably, this block A consists of a poly(butyl acrylate).

According to a first embodiment of the invention, said or at least one of said block copolymer(s) corresponds to the formula SBM, where S, B and M respectively denote a polystyrene block, a 1,4-polybutadiene block. and a predominantly syndiotactic poly(methyl methacrylate) block.

Thus, the composition according to this first embodiment of the invention can comprise a polystyrene/1,4-polybutadiene/syndiotactic poly(methyl methacrylate) triblock copolymer, and preferably an SBM triblock copolymer sold by the company ARKEMA under the name Nanostrength®.

According to a second embodiment of the invention, said or at least one of said block copolymer(s) corresponds to the formula MAM, where M and A respectively denote a predominantly syndiotactic poly(methyl methacrylate) block and a poly(butyl acrylate) block.

Thus, the composition according to this second embodiment of the invention can comprise a syndiotactic poly(methyl methacrylate)/poly(butyl acrylate)/syndiotactic poly(methyl methacrylate) triblock copolymer, and preferably an MAM triblock copolymer sold by the company ARKEMA under the name Nanostrength®.

Advantageously, said composition according to the invention comprises said block copolymer(s) according to an amount (phr: parts by weight per 100 parts of epoxy resin(s)) of between 10 phr and 60 phr, and even more advantageously of between 15 phr and 30 phr.

According to another characteristic of the invention, said composition comprises at least one epoxy resin of liquid type (i.e. said epoxy resin or at least one of said epoxy resins is of liquid type), it being possible for the liquid epoxy resin(s)/solid epoxy resin(s) mass ratio to be of between 100/0 and 30/70.

Advantageously, said composition is devoid of any epoxy resin of solid type (i.e. said or each epoxy resin of the composition is of liquid type).

It will be noted that the preferential use according to the invention of one or more liquid epoxy resin(s) (i.e. without solid epoxy resin) makes it possible to further minimize the hardness and the tack in the uncured state of said composition, in such a way that the processability and the tack of said composition are further improved.

Advantageously, said composition can thus have, in the uncured state, a Shore A hardness which is less than 10, and preferably substantially equal to 0, and a highly tacky nature at ambient temperature with respect to metal materials, such that it adheres satisfactorily to said hollow metal body.

Preferably, said or each epoxy resin is derived from bisphenol A or F, and, even more preferably, said or each epoxy resin is a diglycidyl ether of bisphenol A (abbreviated to “DGEBA”) resin.

Advantageously, said composition according to the invention can comprise various types of surfactants, without the latter having an effect on its properties, and, according to an example of implementation of the invention, it can be devoid of surfactant.

According to another characteristic of the invention, said composition can comprise, in the expanded state, closed cells and a degree of water absorption at 180° C. which is less than or equal to 5%, which is advantageously reflected by a minimal water absorption during use.

A process for manufacturing, according to the invention, said expanded mastic composition comprises:
a) thermomechanical mixing of the expandable composition, which also comprises:
   a swelling agent (for example, of activated azodicarbonamide type, according to an amount that may range from 1 to 4 phr),
   a curing agent (for example, of activated dicyandiamide type, according to an amount that may range from 5 to 15 phr), and
   one or more mineral filler(s) according to a total amount that may range from 20 to 80 phr, and which is (are), for example, chosen from silicas, alumina trihydrate, magnesium hydroxide, kaolin, clays, chalk, and mixtures thereof;
b) forming of the expandable composition obtained (e.g. by extrusion, injection, compression, etc.), and then
c) expansion of the composition formed, by heating in an oven and in contact with said hollow metal body, for example by cataphoresis, in order to obtain the expanded composition.

It will be noted that the compositions according to the invention also comprise, in addition to said swelling agent, said curing agent and said filler(s), all or some of the other ingredients normally used in expandable mastic compositions.

A hollow metal body according to the invention is filled with a structural reinforcement element based on said hot-expanded mastic composition according to the invention as defined above.

According to another characteristic of the invention, said hollow body may be intended to form a body panel for a motor vehicle, an airborne vehicle or a space vehicle, which is filled with said structural reinforcement element, which can then be in the shape of a sheet.

A use, according to the invention, of said expandable or expanded composition concerns the manufacture of items or semi-finished products for the structural reinforcement and/or sound insulation of hollow metal bodies.

The abovementioned characteristics of the present invention, and also others, will be understood more clearly upon reading the following description of several examples of the implementation of the invention, given by way of nonlimiting illustration.

### EXAMPLES

Five expandable mastic compositions A, B, C, D and E not in accordance with the invention (i.e. according to the prior art), which are each based on a mixture of two epoxy resins, respectively solid and liquid, of “DGEBA” type which each also comprise, in a known manner, a flexibilizer of nitrile rubber-modified “DGEBA” epoxy resin type (this resin is sold under the name “Struktol Polydis 3604”), were prepared.

Six expandable compositions I1, I2, I3, I4, I5 and I6 according to the invention, which are each based on a single liquid epoxy resin and which each comprise, in place of this modified resin, a block copolymer corresponding to the abovementioned formula MAM and sold by ARKEMA under the name Nanostrength® (methyl methacrylate/butyl acrylate/methyl methacrylate triblock), were also prepared.

Each of these compositions A to E and I1 to I6 also comprises in particular the same swelling agent consisting of an activated azodicarbonamide, the same curing agent of activated dicyandiamide type and the same dilution filler which is predominantly based on silica and alumina trihydrate (abbreviated to “ATH”) and which also comprises a clay.

More specifically, the compositions A, B, C, D and I1, I2, I3 and I4 also comprise, as surfactant, the same surfactant T1 of silicone polyether type, while the compositions E and I5 are devoid of surfactant and the composition I6 comprises a surfactant T2 of hydroxylated liquid polybutadiene type.

For these compositions A to E, the following were, moreover, varied:
the mass ratio of solid epoxy resins/liquid epoxy resins (this ratio being 60/40 for the compositions A, B and E and, conversely, 40/60 for the compositions C and D), and
the amount of swelling agent (either 3.5 phr, or 1.9 phr).

These expandable compositions A to E and I1 to I6 were prepared by carrying out the same thermomechanical mixing process for each of these compositions, and then each expandable composition thus obtained was formed via compression and then cut into size.

The expandable compositions thus formed were then expanded by heating in an oven (at two temperatures of approximately 160° C. and 180° C.). For each composition, certain samples were heated “freely” on an anti-adhesive paper, and others were heated in contact with sheets intended to form a hollow body filled with the corresponding expanded composition (these sheets consist of crude, galvanized or electrogalvanized steel).

The compositions A to E have the following formulations (phr: parts by weight per 100 parts of epoxy resin(s)):

TABLE 1

| | A | B | C | D | E |
|---|---|---|---|---|---|
| Solid/liquid “DGEBA” | 60/40 | 60/40 | 40/60 | 40/60 | 60/40 |
| resins mass ratio | | | | | |
| Swelling agent (phr) | 3.5 | 1.9 | 3.5 | 1.9 | 1.9 |
| “Struktol Polydis 3604” | 30 | 30 | 30 | 30 | 30 |
| flexibilizer (phr) | | | | | |
| Curing agent (phr) | 8.6 | 8.6 | 8.6 | 8.6 | 8.6 |
| Mineral fillers (phr) | 61.4 | 61.4 | 61.4 | 61.4 | 61.4 |
| Surfactant T1 (phr) | 2.1 | 2.1 | 2.1 | 2.1 | — |

The compositions I1 to I6 according to the invention have the following formulations (phr: parts by weight per 100 parts of epoxy resin(s)):

TABLE 2

| | I1 | I2 | I3 | I4 | I5 | I6 |
|---|---|---|---|---|---|---|
| Solid/liquid | 0/100 | 0/100 | 0/100 | 0/100 | 0/100 | 0/100 |
| “DGEBA” resins | | | | | | |
| mass ratio | | | | | | |
| Swelling agent | 1.9 | 1.9 | 1.9 | 1.9 | 1.9 | 1.9 |
| (phr) | | | | | | |
| “Struktol Polydis | — | — | — | — | — | — |
| 3604” flexibilizer | | | | | | |
| (phr) | | | | | | |
| MAM triblock | 20 | 20 | 20 | 20 | 20 | 20 |
| copolymer | | | | | | |
| Nanostrength ® | | | | | | |
| powder (phr) | | | | | | |
| Curing agent (phr) | 13.8 | 13.8 | 11.4 | 11.4 | 13.8 | 13.8 |
| Mineral fillers | 61.3 | 71.8 | 61.3 | 71.8 | 71.8 | 71.8 |
| (phr) | | | | | | |
| Surfactant T1 or | T1 | T1 | T1 | T1 | — | T2 |
| T2 (phr) | 2.1 | 2.1 | 2.1 | 2.1 | | 2.1 |

Measurements were carried out on each composition A to E and I1 to I6 thus prepared, both in the expandable and uncured state (initial density, vertical creep stability under hot conditions (160° C.), Shore A hardness and “uncured” tack) and in the expanded state (expansion by volume at 160° C. and at 180° C., final density, degree of water absorption at 160° C. and at 180° C.).

In order to measure the vertical creep stability, the following process was carried out.

A sample of the “uncured” mastic (40×40×5 mm) was applied manually and with a slight pressure to a metal sheet, and the initial position (pᵢ) of this mastic was pinpointed. This sheet was then suspended vertically in an oven, for 30 minutes at 160° C. After the plate thus obtained had been taken out of the oven and cooled to ambient temperature (23° C.), the final position (p_{f}) of the expanded mastic was pinpointed. The creep stability is measured by the vertical displacement of the mastic during the heating step: d=p_{f}−pᵢ (in mm)

In order to measure the Shore A hardness of the “uncured” mastic, the process was carried out according to ISO standard 868.

In order to characterize the “uncured” tacky nature of each composition with respect to the sheets in contact with which the expansion is carried out (evaluation of the tack), four levels 0, 1, 2 and 3 were distinguished, representing a respectively very weak, medium, strong and very strong tacky nature.

Tables 3 and 4 hereinafter give the results obtained, respectively, for the compositions A to E not in accordance with the invention and for the compositions I1 to I6 according to the invention.

TABLE 3

| | A | B | C | D | E |
|---|---|---|---|---|---|
| Initial density | 1.32 | 1.32 | 1.31 | 1.31 | 1.32 |
| Expansion by volume at | 111 | 100 | 108 | 94 | 78 |
| 160° C. (%) | | | | | |
| Final density | 0.62 | 0.66 | 0.63 | 0.68 | 0.75 |
| Degree of water | 13 | 3 | 26 | 10 | 1 |
| absorption at 160° C. (%) | | | | | |
| Degree of water | 32 | 8 | 38 | 35 | 2 |
| absorption at 180° C. (%) | | | | | |
| Expansion by volume at | 137 | 119 | 118 | 117 | 90 |
| 180° C. (%) | | | | | |
| Vertical creep stability | 7 | 8 | 6 | 8 | 34 |
| (d in mm) | | | | | |
| “Uncured” Shore A | 48 | 45 | not | 6 | — |
| hardness (e = 5 mm) | | | measur- | | |
| | | | able | | |
| “Uncured” tack at | ≈0 | ≈0 | 2 | 2 | ≈0 |
| ambient T (approx. 20° C.) | | | | | |

TABLE 4

| | I1 | I2 | I3 | I4 | I5 | I6 |
|---|---|---|---|---|---|---|
| Initial density | 1.21 | 1.23 | 1.21 | 1.24 | 1.24 | 1.29 |
| Expansion by | 93 | 99 | 92 | 98 | 127 | 131 |
| volume at 160° C. | | | | | | |
| (%) | | | | | | |
| Final density | 0.62 | 0.62 | 0.62 | 0.62 | 0.54 | 0.56 |
| Degree of water | 3 | 3 | 3 | 3 | 2 | 2 |
| absorption at | | | | | | |
| 160° C. (%) | | | | | | |
| Degree of water | 4 | 4 | 3 | 4 | 3 | 3 |
| absorption at | | | | | | |
| 180° C. (%) | | | | | | |
| Expansion by | 110 | 112 | 110 | 113 | 153 | 166 |
| volume at 180° C. | | | | | | |
| (%) | | | | | | |
| Vertical creep | 7 | 7 | 12 | 7 | 7 | 8 |
| stability (d in | | | | | | |
| mm) | | | | | | |
| “Uncured” Shore | not | not | not | not | not | not |
| A hardness (e = 5 mm) | measureable | measureable | measureable | measureable | measureable | measureable |
| “Uncured” tack | 3 | 3 | 3 | 3 | 3 | 3 |
| at ambient T | | | | | | |
| (approx. 20° C.) | | | | | | |

Table 3 shows that, among the compositions A to E not in accordance with the invention, only the composition B exhibits a compromise of expansion properties which come close to those desired. It will be noted, however, that this composition B has a degree of water absorption at 180° C. which is not satisfactory, since it is too high (equal to 8%), and a “uncured” Shore A hardness which is also too high (equal to 45) and a “uncured” tack with respect to said sheets which is insufficient (of level≈0).

It will be noted, in general, that none of these compositions A to E exhibits a “uncured” tack which is satisfactory with respect to these sheets, nor an average “uncured” Shore A hardness that is sufficiently low (i.e. close to 0), nor, at the same time, satisfactory water absorption properties (i.e. minimal absorption).

Table 4 shows that all the compositions I1 to I6 according to the invention exhibit not only satisfactory expansion properties, but also, in comparison with the compositions A to E:
a clearly increased “uncured” tack (always of level 3, i.e. maximal), which attests to an improved adhesion of the mastic according to the invention with respect to the metal material in contact with it,
a minimized “uncured” Shore A hardness (of the order of 0), which represents a significant improvement in the processability of the compositions I1 to I6, irrespective of the forming process used,
a degree of water absorption that is clearly reduced, both at 160° C. and at 180° C. (this degree is on average 3% for the compositions I1 to I6, against 10.6% and 23% for the average degrees of the compositions A to E at 160° C. and at 180° C., respectively, i.e. an average reduction in this degree, for the compositions I1 to I6, which is greater than or equal to 70%), and
a preserved vertical creep (similar to or even less than that of the compositions A to E).

In particular, it emerges from these Tables 3 and 4 that the composition I5 according to the invention, which is devoid of surfactant, exhibits, in comparison with the composition E not in accordance with the invention, which is also devoid of surfactant:
a degree of expansion which is much greater than that of this composition E (63% greater at 160° C. and 70% greater at 180° C.),
a very reduced vertical creep compared with that of this composition E (decreased by close to 80%),
a clearly improved “uncured” tack with respect to the metal material of the sheets (level 3 instead of ≈0), and
a degree of water absorption which is substantially preserved compared with that of this composition E (both at 160° C. and 180° C.).

It also emerges from table 4 that the nature of the surfactant used (e.g. silicone polyether or liquid polybutadiene) has virtually no effect on the properties of the compositions according to the invention, as shown by all the properties of expansion, water absorption, vertical creep stability, hardness and tack of the composition I6 in comparison with those of the compositions I1 to I4.

Finally, it will be noted that the combination of a single specifically liquid epoxy resin with the triblock copolymer of formula MAM or SBM according to the invention makes it possible in particular to minimize the “uncured” hardness and to maximize the “uncured” tack of the corresponding compositions according to the invention, with respect to said metal material, which renders said compositions particularly advantageous for the structural reinforcement of hollow metal bodies, such as body panels for motor vehicles, airborne vehicles or space vehicles.

1. Hot-expandable or -expanded mastic composition which can be used for the structural reinforcement of a hollow metal body, said composition being based on at least one epoxy resin, characterized in that said composition also comprises at least one block copolymer chosen from the group consisting of copolymers of formula SBM and of formula MAM, where S, B, M and A respectively denote polymeric blocks predominantly derived from a vinylaromatic monomer, from a conjugated diene monomer, from methyl methacrylate and from an alkyl acrylate or methacrylate.

2. Composition according to claim 1, characterized in that M denotes a poly(methyl methacrylate) block.

3. Composition according to claim 1 or 2, characterized in that B denotes a polybutadiene block.

4. Composition according to claim 1 or 2, characterized in that A denotes a poly(butyl acrylate) block.

5. Composition according to claims 2 and 3, characterized in that said or at least one of said block copolymer(s) corresponds to the formula SBM, where S, B and M respectively denote a polystyrene block, a 1,4-polybutadiene block and a predominantly syndiotactic poly(methyl methacrylate) block.

6. Composition according to claims 2 and 4, characterized in that said or at least one of said block copolymer(s) corresponds to the formula MAM, where M and A respectively denote a predominantly syndiotactic poly(methyl methacrylate) block and a poly(butyl acrylate) block.

7. Composition according to one of the preceding claims, characterized in that it comprises said block copolymer(s) according to an amount (phr: parts by weight per hundred parts of epoxy resin(s)) of between 10 phr and 60 phr.

8. Composition according to claim 7, characterized in that it comprises said block copolymer(s) according to an amount of between 15 phr and 30 phr.

9. Composition according to one of the preceding claims, characterized in that it comprises at least one epoxy resin of liquid type, the liquid epoxy resin(s)/solid epoxy resin(s) mass ratio being of between 100/0 and 30/70.

10. Composition according to claim 9, characterized in that it is devoid of epoxy resin of solid type.

11. Composition according to one of the preceding claims, characterized in that said or each epoxy resin is derived from bisphenol A or F.

12. Composition according to claim 11, characterized in that said or each epoxy resin is a diglycidyl ether of bisphenol A resin.

13. Composition according to one of the preceding claims, characterized in that it is devoid of surfactant.

14. Composition according to one of the preceding claims, characterized in that it has, in the uncured state, a Shore A hardness which is less than 10, and preferably substantially equal to 0.

15. Composition according to one of the preceding claims, characterized in that it is tacky with respect to metal materials at ambient temperature and in the uncured state.

16. Composition according to one of the preceding claims, characterized in that it comprises, in the expanded state, closed cells and a degree of water absorption at 180° C. which is less than or equal to 5%.

17. Process for manufacturing an expanded composition according to one of the preceding claims, characterized in that it comprises:
thermomechanical mixing of the expandable composition, which also comprises a swelling agent, a curing agent and one or more mineral filler(s),
forming of the expandable composition obtained, and then
expansion by heating of the formed composition in contact with said hollow metal body, in order to obtain the expanded composition.

18. Hollow metal body filled with a structural reinforcement element based on a hot-expanded mastic composition, characterized in that said composition is as defined in one of claims 1 to 16.

19. Hollow body according to claim 18, characterized in that it is intended to form a body panel for a motor vehicle, an airborne vehicle or a space vehicle, which is filled with said structural reinforcement element, which is in the shape of a sheet.

20. Use of a composition according to one of claims 1 to 16, for the manufacture of items or semi-finished products for the structural reinforcement and/or the sound insulation of hollow metal bodies.
